(19) United States
(12) Patent Application Publication
(10) Pub. No.: US 2024/0359237 A1
(43) Pub. Date: Oct. 31, 2024

(54) DETERMINATION AND MITIGATION OF ANOMALOUS INTERLAYER TEMPERATURE IN MANUFACTURING PROCESSES

(71) Applicant: Addiguru, LLC, Baton Rouge, LA (US)

(72) Inventors: Shuchi P. Khurana, Houston, TX (US); Darshan Thakkar, Baton Rouge, LA (US)

(21) Appl. No.: 18/648,013

(22) Filed: Apr. 26, 2024

Related U.S. Application Data
(60) Provisional application No. 63/499,136, filed on Apr. 28, 2023.

(51) Int. Cl. B22F 10/85; B22F 10/28; B22F 10/31; B22F 10/36; B22F 10/368; B33Y 10/00; B33Y 50/02

(52) U.S. Cl. CPC B22F 10/85; B22F 10/28; B22F 10/31; B22F 10/36; B22F 10/368; B33Y 10/00; B33Y 50/02; B22F 2998/10

(57) ABSTRACT

A method is described herein comprising depositing a layer of powder on a build plate, fusing the layer, wherein the fusing comprises applying an energy source to the deposited layer, iteratively repeating the depositing and the fusing layers to build one or more parts, measuring interlayer temperature (ILT) of at least one region of the one or more parts prior to the fusing of each successive layer, monitoring the measured interlayer temperatures (ILTs) to detect one or more anomalies, and adjusting parameters of the depositing and the fusing upon detecting the one or more anomalies.

### RELATED APPLICATIONS

This application claims priority to U.S. Provisional Patent Application No. 63/499,136, filed Apr. 28, 2023, the entire contents of which is incorporated herein by reference.

### TECHNICAL FIELD

The disclosure herein involves additive manufacturing processes, under an embodiment.

### BACKGROUND

Powder bed fusion is a type of additive manufacturing process where a layer of powder is selectively fused using a focus source of energy such as a laser or an electron beam. Given Powder Bed Fusion (PBF) is a thermally driven process, the interlayer temperature is an important parameter as it indicates the starting temperature for the next consecutive layer. It has been demonstrated that decreased dwell time results in retention of heat in the lased parts. In other words, high interlayer temperature is observed and the additional heat causes overheating of a consecutive layer. Additionally, this overheating results in residual stress build up, part swelling, and distortion. As such, these anomalies not only result in poor part quality but also in failed print and machine breakdown if the swollen part interferes with recoater blade.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a schematic highlighting important components of a powder bed fusion process, under an embodiment.

FIG. 2 is a schematic showing a top view of build layout prior to or during a printing process used for selecting regions of interest, under an embodiment.

FIG. 3 is a schematic showing overview of the process from calibration to classification for detection of anomalous ILT, under an embodiment.

FIG. 4 shows operational flow for prediction of interlayer temperature using a mathematical model, under an embodiment.

FIG. 5 is a schematic showing process flow for use of mathematical model to predict thermal behavior based on real-time variables, under an embodiment.

FIG. 6 is a schematic showing a top view of a lased powderbed with parts experiencing differential heating, under an embodiment.

### SUMMARY OF THE INVENTION

In embodiments, a method comprises depositing a layer of powder on a build plate, fusing the layer, wherein the fusing comprises applying an energy source to the deposited layer, iteratively repeating the depositing and the fusing layers to build one or more parts, measuring interlayer temperature (ILT) of at least one region of the one or more parts prior to the fusing of each successive layer, monitoring the measured interlayer temperatures (ILTs) to detect one or more anomalies, and adjusting parameters of the depositing and the fusing upon detecting the one or more anomalies.

In embodiments, the depositing and the fusing comprises a recoater blade iteratively depositing a new layer of powder after the fusing of a prior layer.

In embodiments, the depositing and the fusing comprises lowering the build plate a set distance after the fusing of each layer.

In embodiments, the set distance is in the range of 20-100 micrometers.

In embodiments, the method comprises provides a user interface for selection of the at least one region.

In embodiments, at least one sensor comprises a thermal camera.

In embodiments, the measuring comprises calibrating the thermal camera.

In embodiments, the calibrating comprises construction of a black body duplicate of the one or more parts using materials and procedures of an intended build of the one or more parts.

In embodiments, the calibrating comprises heating and measuring a temperature of the black body duplicate.

In embodiments, the calibrating comprises adjusting emissivity settings of the thermal camera until the thermal camera accurately measures the temperature of the black body duplicate.

In embodiments, the calibrating comprises heating and measuring temperature of the build plate.

In embodiments, the calibrating comprises correlating the temperature of the build plate with temperature detected by the thermal camera.

In embodiments, the calibrating comprises using information of the correlation to adjust emissivity settings of the thermal camera until the thermal camera accurately measures a correlation adjusted temperature of the build plate.

In embodiments, the calibrating comprises performing a perspective calibration.

In embodiments, the energy source comprises a laser.

In embodiments, the energy source comprises an electron beam.

In embodiments, the one or more anomalies comprises an anomalous increase in the measured ILTs.

In embodiments, the anomalous increase comprises a measured ILT exceeding a threshold value.

In embodiments, the anomalous increase comprises a rate of change of the measured ILTs exceeding a threshold value.

In embodiments, the anomalous increase comprises a rate of change of measured ILT for a region of the at least one region exceeding an average rate of change of measured ILTs for all other regions of the at least one region.

In embodiments, the adjusting the parameters comprises increasing cool time between layers.

In embodiments, the adjusting the parameters comprises lowering power of the energy source.

In embodiments, the one or more anomalies comprises an anomalous decrease in the measured ILTs.

In embodiments, the anomalous decrease comprises a measured ILT falling below a threshold value.

In embodiments, the anomalous decrease comprises a rate of change in measured ILTs falling below a threshold value.

In embodiments, the anomalous decrease comprises a rate of change of measured ILTs for a region of the at least one region falling below an average rate of change of measured ILTs for all other regions of the at least one region.

In embodiments, the adjusting the parameters comprises decreasing cool time between layers.

In embodiments, the adjusting the parameters comprises increasing power of the energy source.

### DETAILED DESCRIPTION

The disclosure presented herein is directed to a method for actively monitoring interlayer temperature using non-contact sensors such as infrared camera for detection of anomalous rise in interlayer temperature leading to distortion. This real-time data is also parsed to a simulation model to predict thermal behavior so that potential issues can be identified in advance. Furthermore, we propose to use interlayer temperature data to modify printing parameters but not limited to such as dwell times and laser power in real-time for uniform and consistent interlayer temperature as a strategy to mitigate part swelling.

Additive manufacturing, more commonly referred to as 3D printing, is a process of fabricating parts by the deposition of materials in a layer-wise manner. Of the several AM techniques, PBF is a popular way to fabricate complex metal parts by fusion of metal powder in a layer-wise manner.

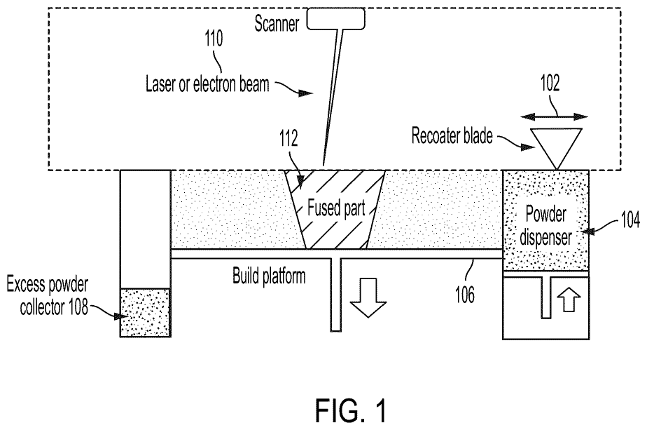

PBF printers work by depositing a thin layer of metal powder onto a substrate using a recoating mechanism and selectively fusing the layer using a focused source of heat or energy. The thickness of such deposition, often referred to as layer height, is typically in the range of 40-100 micrometers. The 3D part to be fabricated is digitally sliced into several 2D sections, and a sintered (lased) layer represents one such 2D section. Once a layer of powder is deposited, a source of focused energy, either a laser or an electron beam, is used to selectively fuse the powder into a 2D cross-section of the part. After fusing, the build platform is moved down by a distance equal to the set layer height to make space for the deposition of new powder. A new layer of powder is then deposited, and the process is repeated until a 3D part is fabricated. FIG. 1 shows a schematic of the process highlighting important components of the process. As seen from the figure, the recoater arm carries 102 a dose of fresh powder 104 to the build plate 106, with excess powder being dropped in the recycling container 108 at the end of the recoater. FIG. 1 shows the positioning of a laser or electron beam 110 which fuses the powder. The process of deposition of powder and sintering is repeated over several layers until the desired 3D part is printed 112.

As the fabrication process relies on the melting and fusion of powder particles to form a layer, thermal fields are the important signature of the build process. One such thermal parameter is the inter-layer temperature. Inter-layer temperature (ILT) refers to the temperature of the part or the region of interest right before the laser starts fusing the next layer. ILT is the temperature of the most recent layer that is dependent on the temperature of the overall part. As with any thermal field, the value of ILT is influenced by the boundary conditions including the temperature of the previously deposited layers. ILT can be measured from one point on the build plate or a collection of points called a region. The region may encompass a part being printed or may partially include a part being printed. This means that the part being printed can be in one region or multiple regions. Region of interest is a user defined area, it can be a particular part, a particular region within a part or the whole build plate. As such, the temperature of previous layer forms the basis or starting point during printing of next layer and can have an impact on the quality of newly printed layer. It is known that thermal conductivity lowers as the print progresses because unlike the initial first layers, heat cannot be rapidly dissipated to the base plate. Interlayer Temperature (ILT) thus becomes an important factor that dictates microstructure development and overall part quality. Therefore, identifying anomalous interlayer temperature behavior and controlling interlayer temperature is an important aspect of ensuring the quality and reliability of the final printed parts in powder bed fusion process.

Unlike the melt-pool temperature parameter which is more closely associated with printing parameters, the interlayer temperature is linked to the part design, layout, dwell time (i.e., time elapsed between the completion of a layer and the start of the next layer), and placement of support structures if any. Support structures in Additive Manufacturing (AM) are temporary structures that provide a base or a scaffolding to the hold parts that otherwise would have collapsed due to overhangs or delicate features. For instance, shorter dwell time is associated with increased interlayer temperature whereas presence of support structures facilitates heat flow towards the build plate for reducing interlayer temperature. Part features such as thin walls or overhangs tend to retain more heat and thereby are more prone to distortion or swelling. Thus, interlayer temperature is important as it can determine the quality of the part being produced. As such, variations in interlayer temperature can greatly affect the part quality. For instance, excessively high interlayer temperature causes overheating of melt-pool for consecutive layer, thereby driving the process to form key-holes. Additionally, reduced thermal gradient due to overheated parts causes retention of heat resulting in residual stress and distortion of part geometry. Real-time monitoring of interlayer temperature becomes a crucial parameter in quality assurance for this thermally driven process.

All objects with a temperature greater than absolute zero emit radiation, the wavelength of radiation being dependent on material, temperature, etc. The method presented here proposes the use of sensors such as an infrared camera to monitor the intensity of these radiations for measuring interlayer temperature during the printing process to notify users of any abnormal rise that can lead to part distortion. Additionally, the real-time temperature readings can be parsed to a mathematical model as input parameters to accurately simulate the thermal behavior in real-time for predicting issues in advance. Furthermore, real-time information on interlayer temperature can be used to modify printing parameters such as dwell time and laser power to obtain uniform interlayer temperature across the printbed.

### Data Acquisition

This system uses data either acquired through another program or from data acquisition sensor such as an infra-red (IR) camera. The data is captured during the printing process and can be procured manually by using the user interface provided by the sensor software or programmatically using Application Programming Interface (API), scripts, etc.

### Camera Installation

Typically, PBF printers have several viewports on the top of the machine which can be used to attach external sensors including cameras as well as mounting attachments inside the processing chamber. The cameras can either be mounted directly inside the 3D printer or attached on the viewport via custom-designed mountings. Either way, the camera must be mounted to give an unobstructed view of the entire build plate and offer the ability to be triggered manually or programmatically.

### Calibration for Temperature

Thermal cameras are typically calibrated using near-ideal blackbody sources which calibrate for the absolute magnitude and non-linear response. However, it is the emissivity of the material that has impact on actual temperature readings. Emissivity is defined as efficiency of a body to emit thermal radiation at a particular temperature compared to radiation from the black body at the same temperature. Emissivity of an object is hence a non-dimensional value between 0 and 1, with the 1 being a perfect black body.

Emissivity values are not only a function of temperature and emitted wavelength but also depend on material, surface roughness, ambient lighting conditions, orientation of camera with respect to surface, etc. As such, accurate measurement of emissivity is extremely difficult. Among several approaches, one way to get an estimated value of emissivity for the PBF process is fabrication of a part using the same material as production parts and under identical processing parameters. Once fabricated, this near ideal black body is fitted with a thermocouple and heated to a known temperature inside the processing chamber. The emissivity on the IR camera is then adjusted for selected regions of interest until the camera reads correct temperature. This completes the calibration process for the solid fused parts that will be fabricated during the printing process. The corrected emissivity value is then used for analysis of temperature fields.

It is important to note that a separate calibration process is needed for powder and fused metal parts as their different surface texture results in different emissivity values, and thus different temperature readings even for same material. Determining emissivity for an IR camera setup for that purpose involves heating the surface and connecting a thermocouple to it. The thermocouple reading will be the correct temperature. The IR camera records a reading which may be different from the thermocouple reading. The temperature of the surface can be varied a few times and readings taken from both IR camera and the thermocouple. This creates a correlation between IR camera reading and the correct temperature readings. The correlation can be used to determine emissivity settings to be used in the IR camera to get the correct temperature readings.

In this work, the absolute or accurate value of emissivity or temperature may not be required. The relative change in the temperature profile is observed for analysis. This makes emissivity related correction immaterial in most cases.

### Selection of Regions of Interest

For temperature measurement of the lased parts, it is necessary to select regions of interest on the infrared image that represent the lased part, portion of a part or the entire build plate. Consideration has to be taken that the location of regions of interest selected varies if the layout of parts fabricated changes across different builds as well as presence of geometries that evolve during the printing process within a same build, i.e., parts with varying cross sections. In general, it is recommended that a region of interest encompasses the entirety of any cross-sectional profile at all stages of a part being manufactured. In other words, the top down projection remains constant during the build.

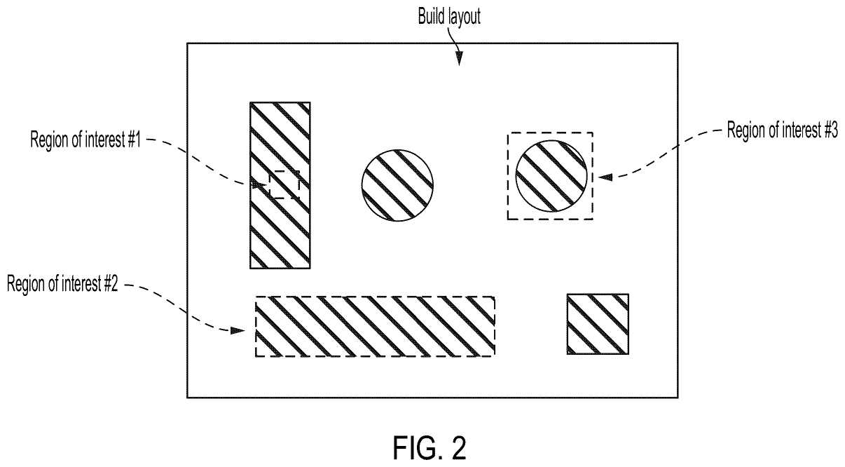

FIG. 2 shows a schematic of the build layout which is typically made available to the user by the printer manufacturer. This build layout view clearly shows the shape, position, orientation, etc. of the parts that will be printed during the process. As such, regions of interest are identified which can comprise of the entire part, a portion of the part or even include areas beyond the part. This selection can be accomplished manually using a Graphical User Interface (GUI) where the user selects location of interests or programmatically by identifying the position of lased parts on the IR image using computer vision techniques which can automatically identify parts in the build layout images. The regions of interest may also be chosen a few layers into the build being started. Also, a generic grid may be automatically created by the software based on the user input. Under this embodiment, the grid encompasses the build plate in sections of equal size instead of focusing on encompassing the parts being manufactured on the build plate.

### Measurement of Interlayer Temperature

An option to the user is the calibration for perspective using a perspective correction or transformation. In perspective transformation, one can change the perspective of a given image to get that picture to orient such that the base plate lines are parallel and the off-axis camera image looks as if the picture is taken on axis. This provides better insights into the required information. In Perspective Transformation, a user provides the points inside the original image that the user wants to display parallel in the new image. A mathematical transformation is done to map the coordinates of those points with the points on the resulting image. The mathematical transformation created is used to transform the rest of the pixels of the original image to the new image. The image is then perspective transformed from the given sets of points to a new image which looks similar to the original image but the orientation is transformed. In OpenCV this is completed by using functions cv2.getPerspectiveTransform and then cv2.warpPerspective. Based on the build layout, one or more regions of interest can be selected for localized measurement of temperature on lased parts and powderbed. The IR camera is triggered to capture data, which is then analyzed to compute interlayer temperature in real time. For example, as shown in FIG. 2, for Region of Interest #1 the interlayer temperature can be the maximum or average temperature in the Region of Interest #1 right before the new layer starts the lasing process.

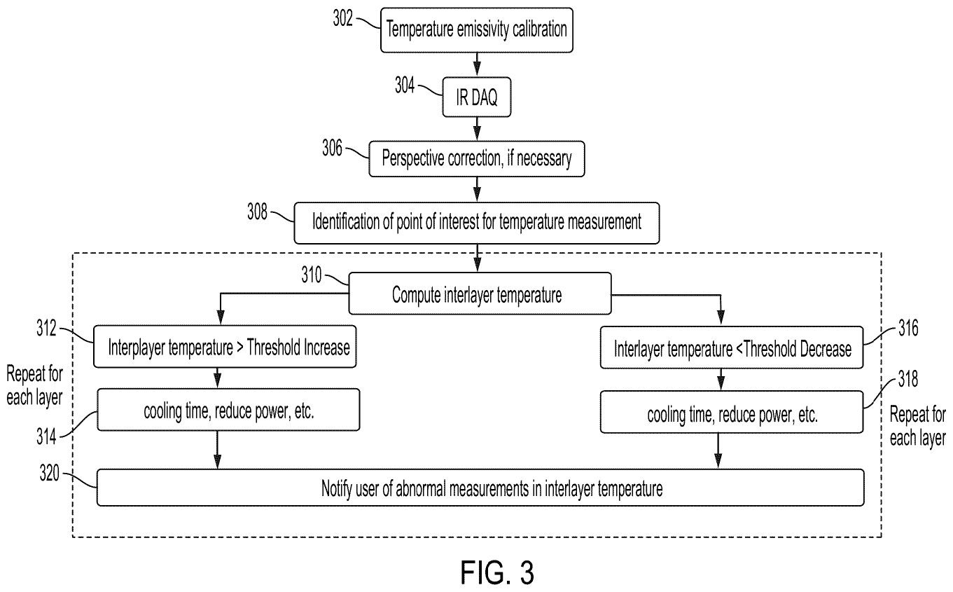

FIG. 3 below shows the process overview from calibration to classification for detection of anomalous ILT.

As seen from FIG. 3, the process begins with the optional step of calibration 302 for emissivity so that approximate temperature readings can be obtained. IR data acquisition 304 then begins and calibration for perspective is performed 306 if necessary. Based on the design of parts fabricated and their layout on the build plate, regions of interest are selected 308 on the IR image that correspond to a location on the part or powderbed as discussed previously. The IR camera is then triggered manually or programmatically to obtain the layer-wise temperature data 310 during the printing process. Note that perspective correction may also be performed throughout the process as necessary. As the IR camera captures the data from the build plate or substrate several times each second, an algorithm is triggered to save the temperature profile of the selected regions after recoat of powder but prior to lasing for the next layer. In general, the very last temperature before lasing the next layer is the inter layer temperature of the regions of interest selected. However, sometimes if there is a discrepancy then an average of a few data points is taken to eliminate the artificial spikes or troughs. A local minima or maxima may show up in the data right before the lasing starts due to sensor anomaly or some other reason. This may incorrectly change the ILT if only one point right before lasing starts is used. In those cases, an average of a few points ranging from a 3 data points to 20 data points before the lasing starts can be used to get an average or a median to weed out the local minima or maxima. The powder layer reduces the temperature detected as the powder is at room temperature inside the machine before it is spread over the lased area. However, the ILT is a consistent observation of the temperature of the powder right before lasing starts. The interlayer temperature obtained for each layer is stored in a database. The method of FIG. 3 compares the ILT for each layer to threshold values. If the interlayer temperature is above a threshold value 312, the method implements procedures 314 to reduce temperature, i.e. increase cooling time, reduce laser or electron beam power, etc. If the interlayer temperature is below a threshold value 316, the method implements procedures 318 to increase temperature, i.e. reduce cooling time, increase laser or electron beam power, etc. In either event, a user is notified of abnormal measurements in interlayer temperature.

### Classification of Anomalous Interlayer Temperature

Abnormal rise or fall in temperature is reported to be anomalous based on criteria such as (but not limited to) unexpected rate of rise of interlayer temperature, rise (or drop) in interlayer temperature beyond a user set threshold, presence of hotspots for certain or all parts, etc.

Comparing ILT with a Threshold Method

One of the methods to classify ILT as anomalous is direct comparison of the temperature with a user defined threshold as shown in FIG. 3. Based on processing parameters, material, part geometry, etc. the user defines a range within which nominal ILT are to be expected. Any values outside this range are immediately flagged as anomalous. While such Go/No-Go is a simple implementation for identifying what values count as anomalous, the threshold values have to be carefully selected. Machine learning models may be used to automatically determine thresholds.

### Rate of Change Method

The rate of change in ILT can be used a metric for detection of anomalous trends in temperature evolution. While this rate of change can be calculated in various ways, one method to determine anomalous rate of change for each layer is computation of difference in rate of change of ILT for current layer to previous layer(s) and comparing it with user defined range of acceptable change, such as a threshold value. Unlike absolute value of temperature, the rate of change of temperature is computed over a finite number of layers (say previous 5 layers) which is then compared with a user defined threshold to be classified as nominal or anomalous. Another way to determine anomalous rate of change of ILT is via using machine learning models like Support Vector Machine (SVM) and Long-Short Term Memory (LSTM) models.

Comparison with ILT of Neighborhood Part or Region(s) of Interest

Typically, multiple parts are produced simultaneously in a build and a comparison of ILT across different parts can be carried out to identify area or parts with anomalous ILT behavior. Rate of change of ILT is determined for each region of interest or part by computing the difference in current temperature reading to temperature values seen for previous layer(s). The rate of change of ILT may be calculated using the data for the layer immediately prior to the current layer, one to ten layers before that or from the current layer to any particular reference layer in the build. The values obtained for each part or region of interest are compared with values obtained for the rest of the parts in the build to identify outliers and thus categorize anomalous ILT values. A user defined range, say greater than 1-50% above the mean of the entire group of ROIs, can be used to classify values as outliers.

The user may include a standard bar or a cylinder to the build to serve as a nominal part for comparison with other part(s) on the build plate. This standard bar or cylinder establishes the baseline for nominal ILT. As mentioned in the previous paragraph, the rate of change of ILT is computed for each part including the nominal control sample and outliers are identified on user set criteria. For example, in FIG. 2 Region of Interest #3 could serve as a nominal bar. If the ILT starts changing significantly for Region of Interest #1 and #2 as compared to that of Region of Interest #3, then that will signify an anomaly. Similarly, if the rate of change of ILT is much higher for Regions of Interest #1 and #2 as compared to that of #3 then that will be determined as an anomaly. Mitigation strategies targeted at that specific ROI are devised. Under an embodiment, operational parameters are locally adjusted depending on the correct mitigation solution as well as capabilities of the machine. Under this embodiment, laser parameters are locally changed for different regions or for each point within a part. Under another embodiment, operational parameters are globally adjusted.

Comparisons with Simulation Method

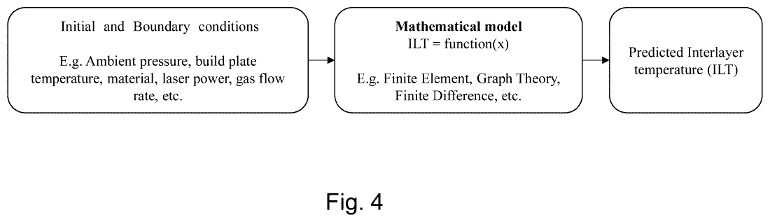

One approach to identify anomalous ILT during the printing process is using a mathematical model to simulate the thermal behavior of the process before the actual start of the build. This mathematical model can be thought of a set of equations that represent the actual printing process given a set of initial and boundary conditions and allows for prediction or simulation. A mathematical model can be expressed as a finite element model, a graph theory model, a finite difference model, etc. as shown in FIG. 4 below. Regardless of how a model is expressed, initial and boundary variables like material, part geometry, processing parameters, etc. are provided as an input to the model to obtain predictions for thermal fields such as ILT over the course of build. After the build is started, readings from the IR camera for each layer are compared with those predicted by the model and used for identification of anomalous ILT.

Another approach to using a mathematical model for identification of anomalous ILT is use of real-time variables recorded using external sensors such as IR camera as well as machine sensor data during the printing process. This approach has the advantage that current, real-time variables are parsed to the model for more accurate prediction of thermal history. As the build progresses, actual readings from the IR camera are compared to the predictions from the mathematical model. Deviations or differences can then be used to classify ILT as anomalous.

### Mitigation Strategies to Avoid Defects in PBF Processes Using Inter Layer Temperature as the Governing Parameter

### Use of Simulation Model to Predict Thermal/Interlayer Temperature Evolution for Optimization of Processing Parameters in Advance

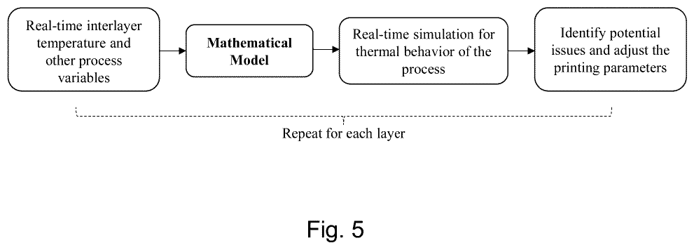

In addition to notifying users of anomalous changes in interlayer temperature, the real-time temperature reading along with other process variables can be parsed to a mathematical model as outlined in FIG. 5 for the prediction of thermal fields in advance. By simulating the thermal behavior of the part during printing, it becomes possible to identify potential issues and adjust the printing parameters to optimize the process before and during the build. As mentioned in the earlier section, the mathematical model takes into account a range of real-time variables, including power, scanning speed, dwell time, material, and interlayer temperature to provide a comprehensive view of the thermal behavior of the process. By using the real-time data from the IR camera and other machine sensors, highly accurate results can be obtained that are based on current processing conditions. This allows for adjustments to be made during the printing, ensuring that any issues are quickly identified and addressed before they can impact the final part's quality. For example, if the simulation predicts that the temperature of a certain part is rising too quickly, the thermal model might suggest that the printer increase the dwell time before starting the next layer to allow the part to cool down to the levels desired. This helps prevent defects such as warping or cracking that could have occurred had the printer followed normal course of action.

Simulation can be used to calculate the amount of dwell time for each layer to the correct temperature. This dwell time can be communicated to the machine at the start of the building process, after every layer, after a certain number of layers or after certain period of time.

The model can also suggest other adjustments based on the captured data, such as increasing or decreasing the laser power, adjusting the scanning speed, etc. The choice of parameters to adjust depends on how largely they impact the desired outcome, often quantified by conducting sensitivity analysis studies for the governing equations for each variable.

### Use of Interlayer Temperature Data for Optimization of Processing Parameters in Real-Time:

By monitoring the Inter Layer Temperature in real-time, adjustments can be made to the printing parameters, such as changing the dwell time or the laser power, based on the measured temperature. If the temperature is too high, these adjustments can help to reduce it, by for example allowing additional dwell time to cool overheated parts and thus prevent swelling. One option is to wait for the ILT to drop to the correct value before sending a signal to the machine to resume the printing process. This can be automatically repeated at every layer.

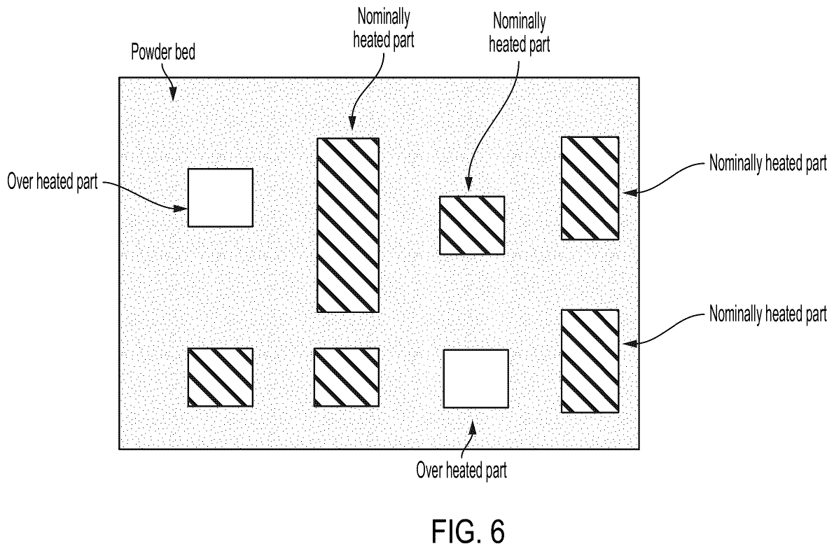

Conversely, if the temperature is too low, adjustments can be made to increase the temperature by increasing laser power or using shorter dwell times and ensure proper layer adhesion. As shown in the schematic in FIG. 6, some parts experience overheating and will appear brighter on the IR camera since hotter parts emit more radiation. As such, increasing dwell time can be one strategy to allow additional cooling time until all parts achieve uniform interlayer temperature before start of next layer.

It is important to ensure that modifications made to processing parameters do not compromise or negatively impact the overall printing process. For instance, while increasing sintering power may be a tempting solution to mitigate low interlayer temperature issues during the printing process, it's important that excessive power can cause keyholing porosity due to vaporizing, a common defect in metal additive manufacturing.

Additionally, when the interlayer temperature deviates significantly from the expected range, the system can notify users and trigger an alarm to indicate anomalous behavior. By promptly identifying anomalies, it becomes possible to prevent any potential issues that may arise from printing with unstable or extreme temperatures. The process of computing interlayer temperature is repeated for each layer and whenever needed, interlayer temperature controlling strategies are executed. While this document mentions changing dwell time and laser power as two possible mitigation methods, other methods are also possible like changing other build parameters like laser speed, gas flow rate, etc. A combination of the variables mentioned above is also a possible solution to mitigate issues due to anomalous change in ILT.

### Other Processes

This determination of anomalous ILT and mitigation is not limited to the Powderbed fusion process. This can be extended to other additive manufacturing processes like directed energy deposition processes.

The concepts herein may be further extended to other manufacturing processes like welding and casting.

Note that powders used in the PBF process are generally metal alloy powders in most cases. However, laser based powder bed fusion is applied to polymer powders as well. So for laser based processes-metal alloy or polymer powders. For Electron Beam processes-metal powders. Metal powders may vary from standard Aerospace alloys like In718, Ti64 etc. to very novel powders that are experimental in some cases to take advantage of this process.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The determination and mitigation of anomalous interlayer temperature in manufacturing processes can be a component of a single system, multiple systems, and/or geographically separate systems. The determination and mitigation of anomalous interlayer temperature in manufacturing processes can also be a subcomponent or subsystem of a single system, multiple systems, and/or geographically separate systems. The components of determination and mitigation of anomalous interlayer temperature in manufacturing processes can be coupled to one or more other components (not shown) of a host system or a system coupled to the host system.

One or more components of the determination and mitigation of anomalous interlayer temperature in manufacturing processes and/or a corresponding interface, system or application to which the determination and mitigation of anomalous interlayer temperature in manufacturing processes is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include determination and mitigation of anomalous interlayer temperature in manufacturing processes can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the determination and mitigation of anomalous interlayer temperature in manufacturing processes and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the determination and mitigation of anomalous interlayer temperature in manufacturing processes and corresponding systems and methods include: microcontrollers with memory (such as electronically erasable programmable read only memory (EEPROM)), embedded microprocessors, firmware, software, etc. Furthermore, aspects of the determination and mitigation of anomalous interlayer temperature in manufacturing processes and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the determination and mitigation of anomalous interlayer temperature in manufacturing processes is not intended to be exhaustive or to limit the systems and methods to the precise forms disclosed. While specific embodiments of, and examples for, the determination and mitigation of anomalous interlayer temperature in manufacturing processes and corresponding systems and methods are described herein for illustrative purposes, various equivalent modifications are possible within the scope of the systems and methods, as those skilled in the relevant art will recognize. The teachings of the determination and mitigation of anomalous interlayer temperature in manufacturing processes and corresponding systems and methods provided herein can be applied to other systems and methods, not only for the systems and methods described above.

The elements and acts of the various embodiments described above can be combined to provide further embodiments. These and other changes can be made to the determination and mitigation of anomalous interlayer temperature in manufacturing processes and corresponding systems and methods in light of the above detailed description.

The invention claimed is:

1. A method comprising,
depositing a layer of powder on a build plate;
fusing the layer, wherein the fusing comprises applying an energy source to the deposited layer;
iteratively repeating the depositing and the fusing layers to build one or more parts;
measuring interlayer temperature (ILT) of at least one region of the one or more parts prior to the fusing of each successive layer;
monitoring the measured interlayer temperatures (ILTs) to detect one or more anomalies;
adjusting parameters of the depositing and the fusing upon detecting the one or more anomalies.

2. The method of claim 1, wherein the depositing and the fusing comprises a recoater blade iteratively depositing a new layer of powder after the fusing of a prior layer.

3. The method of claim 1, wherein the depositing and the fusing comprises lowering the build plate a set distance after the fusing of each layer.

4. The method of claim 3, wherein the set distance is in the range of 20-100 micrometers.

5. The method of claim 1, further comprising providing a user interface for selection of the at least one region.

6. The method of claim 1, wherein at least one sensor comprises a thermal camera.

7. The method of claim 1, wherein the measuring comprises calibrating the thermal camera.

8. The method of claim 7, wherein the calibrating comprises construction of a black body duplicate of the one or more parts using materials and procedures of an intended build of the one or more parts.

9. The method of claim 8, wherein the calibrating comprises heating and measuring a temperature of the black body duplicate.

10. The method of claim 9, wherein the calibrating comprises adjusting emissivity settings of the thermal camera until the thermal camera accurately measures the temperature of the black body duplicate.

11. The method of claim 10, wherein the calibrating comprises heating and measuring temperature of the build plate.

12. The method of claim 11, wherein the calibrating comprises correlating the temperature of the build plate with temperature detected by the thermal camera.

13. The method of claim 12, wherein the calibrating comprises using information of the correlation to adjust emissivity settings of the thermal camera until the thermal camera accurately measures a correlation adjusted temperature of the build plate.

14. The method of claim 8, wherein the calibrating comprises performing a perspective calibration.

15. The method of claim 1, wherein the energy source comprises a laser.

16. The method of claim 1, wherein the energy source comprises an electron beam.

17. The method of claim 1, wherein the one or more anomalies comprises an anomalous increase in the measured ILTs.

18. The method of claim 17, wherein the anomalous increase comprises a measured ILT exceeding a threshold value.

19. The method of claim 17, wherein the anomalous increase comprises a rate of change of the measured ILTs exceeding a threshold value.

20. The method of claim 17, wherein the anomalous increase comprises a rate of change of measured ILT for a region of the at least one region exceeding an average rate of change of measured ILTs for all other regions of the at least one region.

21. The method of claim 17, wherein the adjusting the parameters comprises increasing cool time between layers.

22. The method of claim 17, wherein the adjusting the parameters comprises lowering power of the energy source.

23. The method of claim 1, wherein the one or more anomalies comprises an anomalous decrease in the measured ILTs.

24. The method of claim 23, wherein the anomalous decrease comprises a measured ILT falling below a threshold value.

25. The method of claim 23, wherein the anomalous decrease comprises a rate of change in measured ILTs falling below a threshold value.

26. The method of claim 23, wherein the anomalous decrease comprises a rate of change of measured ILTs for a region of the at least one region falling below an average rate of change of measured ILTs for all other regions of the at least one region.

27. The method of claim 23, wherein the adjusting the parameters comprises decreasing cool time between layers.

28. The method of claim 23, wherein the adjusting the parameters comprises increasing power of the energy source.
